(19) United States
(12) Patent Application Publication
(10) Pub. No.: US 2017/0013301 A1
(43) Pub. Date: Jan. 12, 2017

(54) METHOD TO BROWSE THROUGH RADIO-TELEVISION SERVICES, AND RELATIVE TELEVISION APPARATUS AND REMOTE CONTROL

(71) Applicant: SARONIKOS TRADING AND SERVICES, UNIPESSOAL LDA, Funchal, Madeira (PT)

(72) Inventor: Robert JAMES, Hatfield (GB)

(73) Assignee: Saronikos Trading and Services, Unipessoal Lda, Funchal, Madelra (PT)

(21) Appl. No.: 15/119,498

(22) PCT Filed: Feb. 17, 2014
(86) PCT No.: PCT/EP2014/053025

§ 371 Date: Aug. 17, 2016

(51) Int. Cl. H04N 21/422; H04N 21/482; H04N 21/434

(52) U.S. Cl. CPC H04N 21/42209; H04N 21/4345; H04N 21/4823

(57) ABSTRACT

An apparatus is described that implements a method for browsing through radio-television services, each of said radio-television services belonging to a respective broadcaster from among a plurality of broadcasters, and being contained in a respective broadcasting multiplex among a plurality of broadcasting multiplexes, said method comprising the steps of identifying for each radio-television service to which broadcaster and/or to which multiplex of the plurality of broadcasters and/or broadcasting multiplexes belong, selecting a service by way of selection means from among the plurality of receivable services and sequentially selecting through the selection means radio-television services belonging to the same broadcaster, or to the same multiplex, of the selected radio-television service.

The present application claims priority from International Patent Application No. PCT/EP2014/053025 filed on Feb. 17, 2014, the disclosure of which is incorporated herein by reference in its entirety.

### FIELD OF THE INVENTION

It is noted that citation or identification of any document in this application is not an admission that such document is available as prior art to the present invention.

The present invention falls within the area of apparatuses that implement methods for browsing through radio-television services, in particular digital terrestrial broadcasting services. In the following radio-television services mean radio and/or television services. To date, television receivers (such as televisions and set-top-boxes), when configured during initial installation, perform a scan of the entire frequency band available, particularly VHF (“Very High Frequency”) and UHF (“Ultra High Frequency”), and generate a list of radio-television services usually adopting the LCN logic (“logical Channel number”) by means of which a progressive number is assigned to each radio-television service.

It is important to specify that the term “radio-television service”, or more generically “service”, is also often incorrectly referred to as “channel”. In fact, with the term “channel” it is meant the portion of the band that, in analog television, was assigned to a service, while in digital television it is meant the portion of the band that includes one or more radio and/or television services contained in a broadcasting multiplex, also called MUX.

For example, in Italy “RAI 1” is a service of the broadcaster, or service provider, RAI. Just to name a few, in Italy the leading providers of radio-television services are RAI, Mediaset and Telecom Italia Media, in Germany ARD, ZDF and RTL, and in the United States of America ABC, NBC, FOX, FX, “The CW” and PBS.

Also, for clarity, the term “program” means the individual television content (for example, a news program), and not the service (for example, “RAI”). Some programs, such as the news, are made up of a single “event”, but there are several programs that can be defined as “containers” and include a number of “events”, such as the program “Domenica in” broadcasted by RAI. Therefore a radio-television service includes a plurality of programs, which in turn comprise one or more events.

It is appropriate to recall here the definition of a broadcasting bouquet. This is the set, or group, of all the radio-television services broadcast by the same broadcaster. In the following description the terms bouquet or broadcaster will be used as a synonym of one another.

In a broadcasting multiplex several tables are currently transmitted that contain information about the RF channel (“radio frequency”), the services contained within it and the events of each service. The base tables have been defined by the organization MPEG (“Motion Picture Expert Group”) under the name PSI (“Program Service Information”), while the DVB organization (“Digital Video Broadcasting”) has added additional tables containing more detailed information about services and additional tables with the list of events. The set of all tables, MPEG and DVB, is called SI (“Service Information”). For example, the list of radio-television services in the broadcasting multiplex is included in the MPEG table called NIT (“Network Information Table”). However, since the list only contains the code assigned to each service, and not its name in clear text, the DVB has added the SDT table (“Service Descriptor Table”), where the name in clear text of the services is necessary to enable television apparatus to display the list of available services.

The SI specifications are contained in ETSI EN 300468, while the guidelines for the application of the specifications are contained in ETSI ETR 101 211.

The LCN numbering is not provided for by either MPEG or DVB: it is transmitted using a descriptor in the NIT table called “user defined”. This descriptor was specified by EACEM (“European Association of Consumer Electronics Manufacturers”).

Therefore, the organization of SI/PSI Tables is somewhat cumbersome and certainly not optimized: this is evidently due to the fact that such tables were not designed by a single unitary standardization authority.

With regard to the configuration of a television apparatus, the latter generates a list of the available services putting them in a pre-established order (usually using the LCN numbers), and presents a screen with a list to the users, who are then free to accept it or to edit such list to their liking.

Once the configuration has been performed, if the user repeatedly presses the next program button “P+” or the previous program button “P−” on the remote control, the apparatus sequentially tunes to the next service, or to the previous one according to the order defined by the LCN. For example, in Italy by repeatedly pressing the “P+” button starting from the service having the LCN=1, the apparatus tunes in sequence to the services “RAI 1”, “RAI 2”, “RAI 3”, “Rete 4” “Channel 5”, “Italy 1”, “LA7”, “MTV”, and so on.

It may occur that the user wishes to view in sequence all the services offered by the same broadcaster, RAI, for example. In Italy, however, these services are placed within four different broadcasting multiplexes and, apart from the three major services “RAI 1”, “RAI 2” and “RAI 3”, the other services are associated with LCN values not being numerically consecutive.

With reference to FIG. 1, a table is illustrated as an example where both the RF channels are indicated in which are transmitted the various broadcasting multiplexes, and the relative LCN number for the services provided by the Italian service provider RAI.

In other words, taking the Italian case as an example, the major broadcasters, not only RAI, but also Mediaset and Telecom Italia Media, transmit a group of services, which are received by television apparatuses and displayed in the form of a list that is created in sorting the services according to LCN numbering, which aren't numerically consecutive. Therefore, it is awkward and not very easy for the user to search for radio and television services transmitted by a single specific broadcaster.

To meet this need, the DVB organization predicted a table called BAT (“Bouquet Association Table”), by bouquet it is meant a group of radio and television services that is transmitted by a single broadcaster. However, at least in Italy, the BAT table is currently not transmitted by any broadcasters. Consequently, manufacturers of television receivers have not implemented any additional methods to allow for browsing through the services offered by a certain bouquet, or similar, compared to that based on the list of services ordered by the LCN logic (with possible corrections introduced by the user).

To overcome this drawback RAI uses an MHP application (“Multimedia Home Platform”), called “RAI Remote Control”, which lets the user know the program currently transmitted and that being immediately successive relative to all the television services of the service provider RAI. The application also allows to easily tune into all the RAI services, even those where the user cannot remember the LCN number (e.g. “RAI News 24”, which currently has the number LCN=48). Unfortunately, the MHP standard is basically only used in Italy, and not all television receivers are configured in order to implement it. Therefore, a user who owns a TV that does not support MHP cannot make use of this application. In fact, the MHP application “RAI Remote Control” requires:
by the user, having a television or set-top box with the MHP platform;
by the broadcaster, sending a particular MHP application.

Additionally, the other Italian broadcasters, which also have their own bouquet of services do not make use of an application similar to that used by RAI.

### SUMMARY OF THE INVENTION

The purpose of the present invention is therefore to provide a method, a television apparatus and a remote control to browse through radio-television services that enable a user to select and easily view in a sequence a list of services belonging to one or more broadcasting multiplexes, in particular services belonging to the same broadcaster.

In summary, the object of the invention is an apparatus and a method to browse through the radio-television services present within a broadcasting multiplex or more broadcasting multiplexes of the same broadcaster, namely a procedure that allows a user to easily change the service and just scroll through the radio and television services belonging to a single broadcaster or a multiplex where a selected service is found.

Therefore, the apparatus and the method according to the invention for browsing through radio-television services, each of said radio-television services belonging to a respective broadcaster and/or broadcasting multiplex of a plurality of broadcasters and/or broadcasting multiplexes, provides for identifying for each radio-television service the broadcaster and/or multiplex to which the plurality of broadcasters and/or television multiplexes belong, selecting a service by selection means from among the plurality of receivable services and sequentially selecting by way of the selection means radio-television services belonging to the same broadcaster or the same broadcasting multiplex of the selected service.

The invention further relates to a television apparatus able to implement the abovementioned method and a remote control configured to interact with said apparatus comprising functional and technical characteristics able to assist a user in browsing through radio-television services.

Further characteristics of the invention are object of the annexed claims which are considered an integral part of the present description.

### BRIEF DESCRIPTION OF THE DRAWINGS

FIG. 1 illustrates an example of a table according to the prior art where both radiofrequency channels, in which the various multiplexes are transmitted, and the LCN numbers relative to an Italian service provider are indicated.

FIG. 2 shows an example of information related to different bouquets in a tabular form.

FIG. 2B illustrates an example of selection means according to the present invention.

FIG. 3 shows an example of a flow chart of the method according to the invention.

FIGS. 4, 5, and 6 illustrate some examples of implementation of the method according to the invention.

FIG. 7 illustrates an example of a logic diagram of a remote control according to the invention.

FIG. 8 shows an example of a block diagram of a remote control according to the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

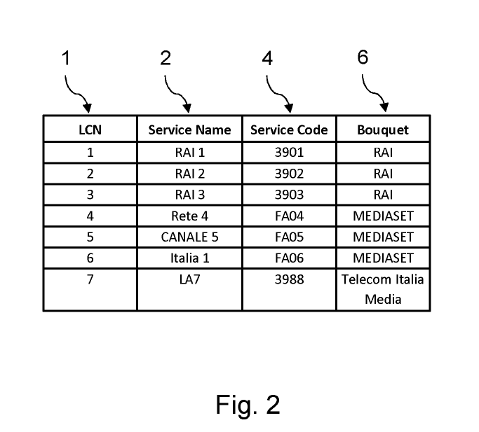

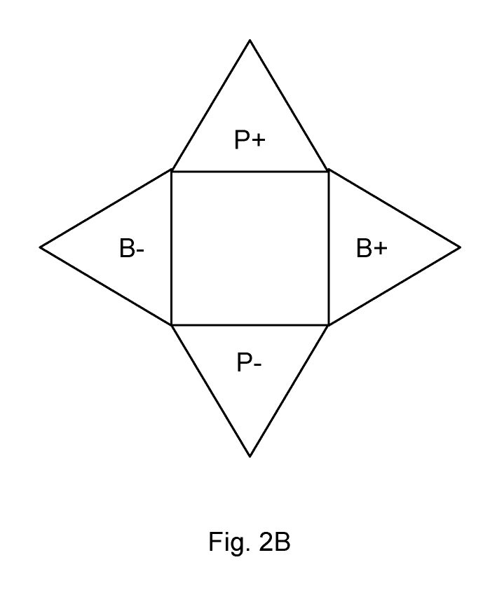

For implementing the method according to the invention, it is necessary that a television apparatus has the information available relating to the bouquets of various broadcasters. When broadcasters transmit their own BAT table (“Bouquet Association Table”) it is possible for the television apparatus to obtain the bouquet information. In this case, broadcasters provide a table that contains an identifier of the bouquet, usually coinciding with the name of the broadcaster, and a list of codes of radio-television services that are part of it. Therefore, the television apparatus, when scanning the broadcasting band, stores, and also reads the bouquet information, or alternatively generates a list of services that also include, in addition to the usual information (such as the LCN numbering, the code of the service, the name of the service in clear text), an additional column with the name of the broadcaster to whom the service belongs (FIG. 2). The services are still ranked according to the LCN logic, unless of variants are later introduced by a user.

In the case where the BAT table is not transmitted by broadcasters various other solutions can be used as described below.

A first solution consists of the broadcaster transmitting, as per usual, in the NIT table (“Network Information Table”), the list of radio and television services actually present in the broadcasting multiplex, but inserting in the SDT table (“Service Descriptor Table”) the list of all the services of the bouquet with their names in clear text. Advantageously, this first solution does not disrupt actual radio and television receivers: the SDT table contains redundant information for current receivers, but does not affect their normal functioning.

A second solution is to allow the user to manually edit the list of services, manually adding by himself the column with the information of the bouquet, by way of the remote control of the television apparatus. It is indeed likely that the user is familiar with the bouquet belonging to a particular service, or can at least easily obtain such information.

A third solution is to identify the name of the broadcaster of one or more radio-television services considering the names of the same. In fact, the names of radio-television services belonging to certain broadcasters are public information and each broadcaster on its website mentions what are the radio and television services it broadcasts. It is therefore possible for television manufacturers to place within the internal memory contained in the television receiver a list of services associated with a single broadcaster.

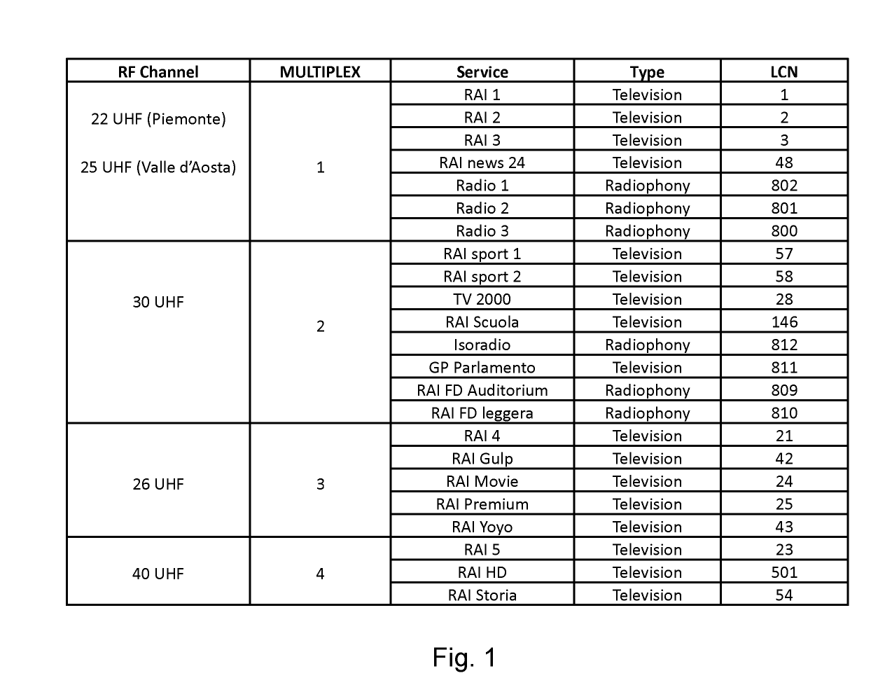

An example of such a list is shown in FIG. 1 for the case of the Italian broadcaster RAI. Similar lists of services and broadcasters can be stored for all the broadcasters that transmit within a particular nation or area. From this combination of radio and television services and broadcasters it is possible to allow the apparatus to sequentially browse through the services belonging to a certain single broadcaster. Similarly, once a radio-television service has been selected, it is possible to understand in which broadcasting multiplex it is located from the table that associates the radio-television services to the multiplexes where they are located, and it is possible to carry out a sequential browsing from among the radio-television services belonging to the same broadcasting multiplex.

According to the solution wherein the manufacturer memorizes in the television receiver apparatus the information relating to the bouquets, it is possible to obtain a further improvement. The information in question may change over time, being as that broadcasters may add new services to their bouquets, or remove existing services. It is possible to overcome this by using the technique called OTA (“Over The Air”), with which the broadcasters are able send software updates to the television apparatus. These updates are received and stored in the television apparatus, such as for instance when it is in standby. The use of the OTA technique assumes the existence of agreements between equipment manufacturers and television broadcasters, the latter have to agree to transmit in their multiplexes the software provided by the manufacturers. Obviously such software may vary depending on the model of the television apparatus, and for this reason an extensive use of the OTA technique requires a potentially significant bandwidth consumption (from which the custom of transmitting updates nightly).

A fourth solution provides that the television apparatus comprises a network interface designed for connection to the Internet. In this case, the device is able to connect to a particular website, such as an ftp site (“file transfer protocol”) maintained by the manufacturer of the same apparatus, and download, or obtain, the bouquets information designed to fill in the bouquets column in the list of radio and television services received by the apparatus. The bouquet information can be, for example, contained in a text file readable by the television apparatus.

Obviously, the apparatus should periodically reconnect to said website to download any available updates. Advantageously, this solution does not exploit the bandwidth dedicated to broadcasting and can be implemented by manufacturers without requiring the intervention of the broadcaster.

In the following description the method according to the present invention is illustrated.

It is assumed therefore that the television apparatus obtains the bouquets information from the broadcasting network, in one of the ways described hereinabove, and that inside the apparatus there is a table where it is associated for each radio-television service the name of the bouquet to which it belongs, in particular that the television apparatus includes first memory means within which the names/codes of radio-television services are stored, each being associated to a name/bouquet identifier.

The method to browse through radio and television services, each of said radio and television services belonging to a respective bouquet of a plurality of bouquet, comprises the steps of:
Identifying each bouquet of a plurality of bouquets and the respective radio-television services associated to them;
Selecting by selection means a bouquet of the plurality of bouquets, and
Selecting by the selection means radio-television services belonging solely to the selected bouquet.

More in detail, the step of identifying each bouquet and the respective radio-television services associated to it provides that the television apparatus reads the bouquet information, for example stored in its first memory means.

With reference to FIG. 2, an example table is illustrated in which bouquet information is inserted, such as a LCN code 1, a name of the radio-television service 2, a radio-television service code 4 and a name of a bouquet 6 associated to radio-television services 2, 4.

The selection means comprise first selection means and second selection means. The selection means comprise for example one or more buttons present on a television apparatus, or on a remote control.

Preferably, the first selection means, additional to the normal selection means in current television apparatus, are achieved by means of a next bouquet button “B+” and a previous bouquet button “B−”. Therefore, the next bouquet button “B+” and the previous bouquet button “B−” allow, starting from the bouquet to which the service currently selected belongs, to change bouquet, namely to select the next or the previous bouquet from among those available, for example, among those identified by the television apparatus.

Additionally, the step of selecting a bouquet of the plurality of bouquets provides for tuning into a radio-television service belonging to said desired bouquet. This means that, for example, by pressing the next bouquet button “B+” the bouquet changes and the television apparatus is tuned to a radio-television service of the next bouquet with respect to the current one.

Preferably, the method provides that the radio-television service tuned among those belonging to the desired bouquet is the one that has the lowest LCN number among all the radio-television services belonging to said bouquet.

To further clarify that mentioned above a brief example is now illustrated, always with reference to the Italian situation. We may suppose that a user tunes the television apparatus to the radio-television service “RAI Movie” having the LCN=24 and belonging to the RAI bouquet. In the event the user presses the next bouquet button “B+”, the television apparatus according to the invention would tune to the service “RETE 4” that has the LCN=4 and belongs to the next bouquet, Mediaset. In fact, in the Mediaset bouquet the service that has lowest LCN in relation to the other services is in fact “RETE 4”.

Preferably, the second selection means are the program buttons (even though in reality it is a button for selecting a service, but users are accustomed to analog TV traditions and call them programs, hence the abbreviation P) next “P+” and the previous program button “P−”, which are usually present on normal remote controls, or on television apparatus, to carry out the so-called “zapping” of available radio-television services.

A peculiarity of the invention is that the next program button “P+” and the previous program button “P−” allow for selecting sequentially, incremental or decremental respectively, (for example, based on LCN numbering) radio-television services belonging to a selected bouquet. In other words, a user is able to browse within a bouquet, selecting only radio-television services that belong to it. For example, if a user has selected the bouquet of the broadcaster RAI, the next program button “P+” and the previous program button “P−” allow for browsing, namely sequentially selecting or tuning, only services belonging to the RAI bouquet.

With reference to FIG. 2B, in a preferred configuration of the selection means, they comprise in addition to the other buttons normally provided on a remote control or on a television apparatus, a keyboard with buttons arranged in the shape of a cross, in which the selection of a bouquet from among said plurality of bouquets is associated to first opposite buttons of said cross, and the selection of radio-television services within said selected bouquet is associated to second opposite buttons of said cross.

In particular, the first opposing buttons are the keys “Right” and “Left” of the cross, while the second opposing buttons are the “Up” and “Down”. The next bouquet function “B+” is assigned to the “Right” button of the cross, the previous bouquet function “B−” is assigned to the “Left” button of the cross, the next service function “P+” is assigned to the “Up” button in the cross, and the previous service function “P−” is assigned to the “Down” button of the cross.

Preferably, the browsing between radio-television services in a bouquet is made in a circular fashion. More in detail, taking as an example the RAI bouquet, if the television apparatus is tuned to the last radio-television service in order of the LCN, for example the service “RAI HD” which currently has the LCN=501, pressing the next program button “P+” would allow for selecting the first service of RAI in the LCN order, being as that the service “RAI 1” has the LCN=1. Similarly, circular browsing takes place if the previous program button “P−” is continuously used, in such a case it would pass from the first service “RAI 1” to the last service “RAI HD”.

Where a user was tuned to a radio-television service that is not part of any bouquet, then the second selection means would only allow browsing based on the LCN numbering.

In a variation of the apparatus and method according to the invention one may think that in particular cases the functioning of the “P+” and “P−” buttons could produce the sequential scan of services not only belonging to a particular bouquet, but of all those belonging to a particular television multiplex.

This could be the case when the so-called local services are received, produced by a broadcaster that, while owning a television multiplex, is not able to produce sufficient services to take full advantage of the transmission capacity of a broadcast channel, where the relative multiplex can accommodate for example six services transmitted using DVB-T. In this case, the broadcaster uses a part of the television multiplex to host their services and rent the remaining part of the television multiplex to another local broadcaster that does not have its own multiplex. This is possible due to the way in which the table stored in the first memory means of the television set is organized. In fact, as can be seen from the example of FIG. 1, among the data stored for each radio-television service, there is the identifying data of the multiplex within which a radio-television service is hosted. This data relative to the television multiplex is nothing more than the number of the channel on which the multiplex is transmitted, e.g. the old analog television system of numbering channels (first column of FIG. 1).

Therefore, when an examination of the above table reveals that a particular multiplex contains more than one broadcaster, the scan of the multiplex obtained by pressing the buttons “P+” and “P−” produces the display of not only the main bouquet contained in the television multiplex, but once the main bouquet has finished, it continues the display of all the other television services contained in said multiplex even if they belong to another bouquet. This function could make sense because, especially with regard to the services of the local or regional broadcasters, the type of information and programs broadcast within a multiplex, also host to more broadcasters, is usually similar (that is of the same type of content for example, sports, entertainment, news, etc.) and the user may be interested in continuing to select programs of a similar type or content.

A further embodiment of the apparatus and the method according to the invention provides that the selection means P+, P− allow to change the bouquet once all radio-television services present in the current bouquet have been selected, or tuned.

More in detail, the change of bouquet provides for selecting a radio-television service belonging to a second bouquet, wherein said radio-television service has a LCN number immediately following the starting service from which the browsing is initiated in the previously selected bouquet. For instance, always with reference to the Italian situation, if the zapping has been initiated from a RAI service, once all radio-television services present in the RAI bouquet have been selected, or tuned, by pressing the “P+” button the next tuned service will be “RETE 4” which has lowest LCN in the Mediaset bouquet, that is the next one departing from the RAI bouquet.

In this case, the method according to the invention provides for browsing through radio-television services belonging to one or more bouquets only by using the usual selection means, i.e. the “P+” and “P−” buttons, causing them to function when necessary as if they were next bouquet buttons “B+” and previous bouquet “B−”.

This variant can be enabled after a relative activation via the menu of the television apparatus, or by using the colored buttons on the remote control (for example, Red, Green, Yellow and Blue).

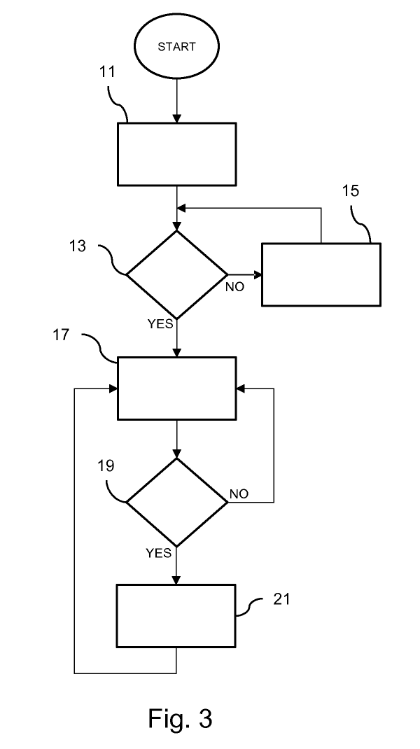

With reference to FIG. 3, this mode of operation, is illustrated by an example, examining Italian broadcasters.

It is assumed that the user, once having turned on the television apparatus (START), would tune in to a starting radio-television service (step 11), for example, “RAI 2”, pressing the number 2 button on the remote control. At this point, at step 13, the method provides for verifying whether the current television service belongs to a first bouquet. In this case, since “RAI 2” is part of the RAI bouquet, browsing inside the bouquet RAI is automatically activated (step 17), and therefore, by successively pressing the button “P+”, the television apparatus changes services and tunes to “RAI 3”, and then to the other RAI services (for example, “RAI News 24”, “RAI History”, “RAI Movie”, etc.), preferably in the order defined by the current LCN numbering. If at step 13 the current service does not belong to any bouquet, step 15 provides for browsing the radio-television services by simply following the LCN numbering.

At step 17 browsing through radio-television services within the same first bouquet takes place using the “P+” or “P−” buttons.

With each change of radio-television service performed, in step 19 the method provides for controlling if all the services belonging to the first bouquet have been displayed, or tuned. If this is not the case, it returns back to step 17, otherwise it means that all the RAI radio-television services have been terminated, and it would pass once again to “RAI 1”, due to the circular browsing fashion.

In the variant described herein, however, at this point, being as that the services of the RAI bouquet have terminated, i.e. they have all been tuned by the television apparatus at least once, a further pressing of the button “P+” carries out the transition to a radio-television service belonging to a second bouquet, different from that of the first RAI bouquet, but having a LCN number immediately successive (or previous, in the case of pressing the button “P−”) to that of the starting service (step 21), namely the one from which the browsing of the first bouquet began (which in the example shown corresponds to the service “RAI 2”).

The service of the bouquet immediately following the bouquet of the starting service corresponds to “Rete 4”. From step 21 the system returns to step 17 browsing through by bouquet. Therefore, a further pressing of the button “P+” starts the browsing within the Mediaset bouquet, as “Rete 4” belongs to the bouquet Mediaset. At the end of browsing through the radio-television services belonging to the Mediaset bouquet, pressing the button “P+” allows for automatically switching to the service “LA7”, as it is the first successive non-Mediaset service, in order of LCN in relation to “Rete 4”, the latter being the service from which browsing of the Mediaset bouquet started.

It is important to note that this “mixed” mode of browsing assumes that the television apparatus stores within its first memory means the starting service from which the bouquet browsing began, so as to know, after the browsing of the bouquet has finished, on which service it should tune in case of further pressing of the button “P+”.

Furthermore, it is clear that the procedure described above has a similar function in the case in which a user acts continuously upon the button “P−”.

Obviously, in the case wherein the user has edited the list of radio-television services by changing the original LCN numbering, the service on which the television apparatus should tune to once the browsing within a first bouquet has finished, is the first service that does not belong to the first bouquet and that is, in terms of the modified LCN, the lowest service belonging to a bouquet immediately successive to the first bouquet from where the browsing began.

The activation of the procedure described above (which as mentioned above could take place via the menu, rather than with the colored buttons on the remote control) may be accompanied by appropriate explanations to the user, such as text and sub-titles on the display means associated to said television apparatus, at the time of activation.

A further embodiment of the invention provides that said selection means allow the selection of a default bouquet. In particular, the selection means comprise the colored buttons of a remote control. Therefore, each colored button corresponds to a predetermined, different bouquet.

For example, it would be possible to assign the RAI bouquet to the Red button, the Mediaset bouquet to the Green button, the Telecom Italia Media bouquet to the Yellow button and so on. Each time one of the said buttons is pressed, the television apparatus selects, or tunes, the first service (for example, based on the LCN numbering) of the selected bouquet.

Additionally, not only the selection of a bouquet of the plurality of bouquets available, but also the selection of radio-television services within said selected bouquet can be associated with the colored keys present on a remote control. In particular, the selection means may be configured as desired and freely defined, for example, it is possible to decide that the Red button fulfills the function of moving to the next bouquet “B+”, the Green button fulfills the function of returning to the previous bouquet “B−”, the Yellow button fulfills the function of selecting the next program “P+” and the Blue button fulfills the function of selecting the previous program “P−”, thus allowing for selecting incrementally, respectively in decrements (e.g. based on the LCN numbering) radio-television services belonging to a selected bouquet.

In general, the selection means can be configured via a menu of the television apparatus, or by means of said colored keys. In practice, it is possible to change the assignment of selecting a bouquet of the plurality of available bouquets and selecting radio-television services within said selected bouquet to buttons provided in the various embodiments and variations of the invention as described herein.

Additionally, the method provides for displaying the radio-television services grouped by bouquet in the form of a list displayed under the menu function.

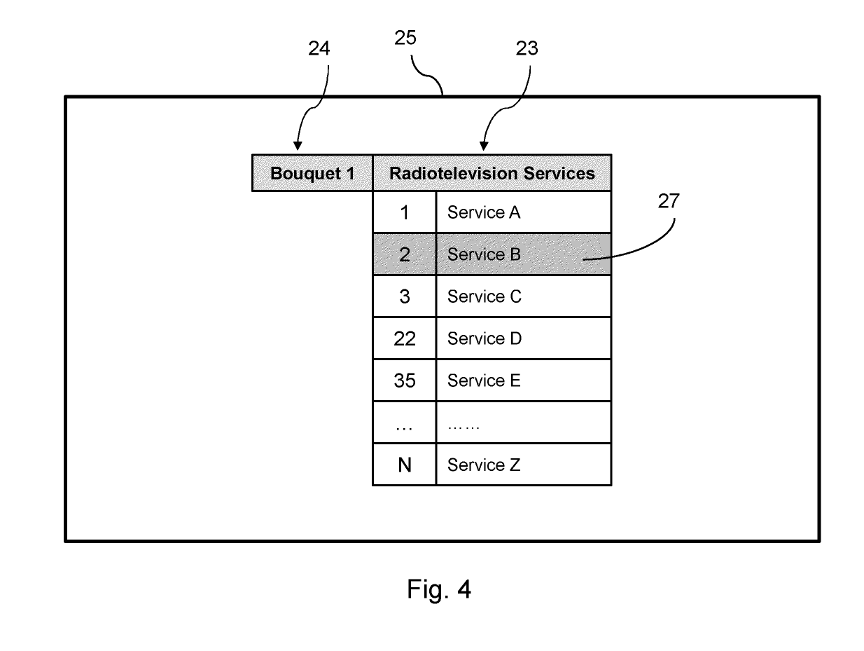

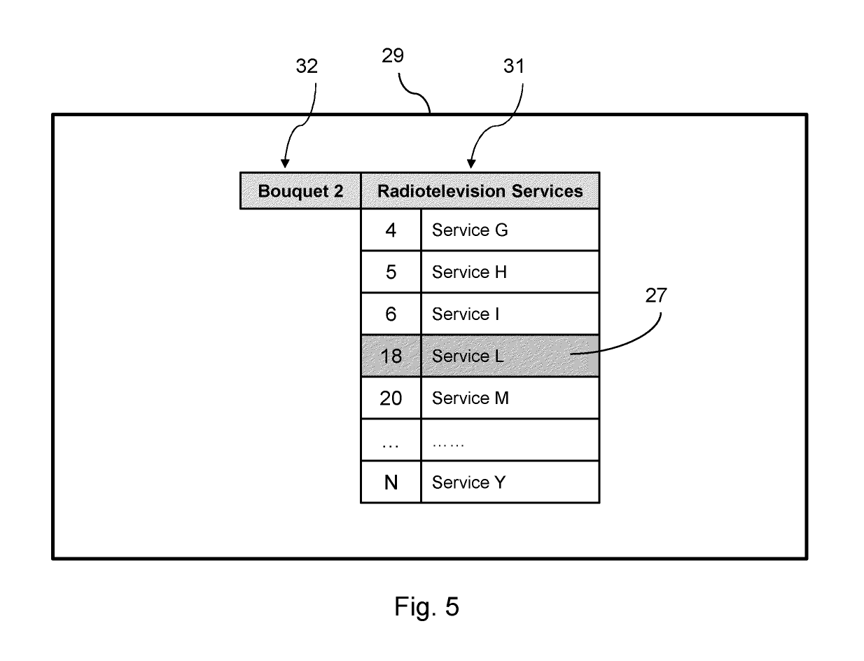

With reference to FIGS. 4 and 5 an example of displaying the first radio-television services 23 belonging to a first bouquet 24 is illustrated. In this case, the first radio-television services 23 in the first bouquet 24 are displayed in a first screen 25 making use of a menu system.

It can therefore be assumed that, in following a command issued by a user, second radio-television services 31 belonging to a second bouquet 32 are displayed in a second screen 29. Therefore, with reference to FIG. 5, an example of a second screen 29 is illustrated comprising the second radio-television services 31 belonging to the second bouquet 32.

It is therefore obvious that the user is able, when the menu function is activated, to switch from the first screen 25 of FIG. 4 to the second screen 29 of FIG. 5 through a command, for instance imparted through a remote control to the television apparatus, and to easily view and select radio-television services 23, 31 within each bouquet 24, 32 transmitted by the various broadcasters.

Both in the first screen 25 of FIG. 4, and in the second screen 29 of FIG. 5, the user is able to select a single television service 23, 31, for example by using a cursor 27 that uniquely identifies the same within its own list. The cursor 27 is able to move in the first screen 25 and in the second screen 29 following a user initiated command. As shown in FIGS. 4 and 5, the cursor 27 is represented by highlighting means that highlight the television service selected by the user. It is clear that the expert in the art will be able to find various embodiments of the cursor 27 as known in the state of the art.

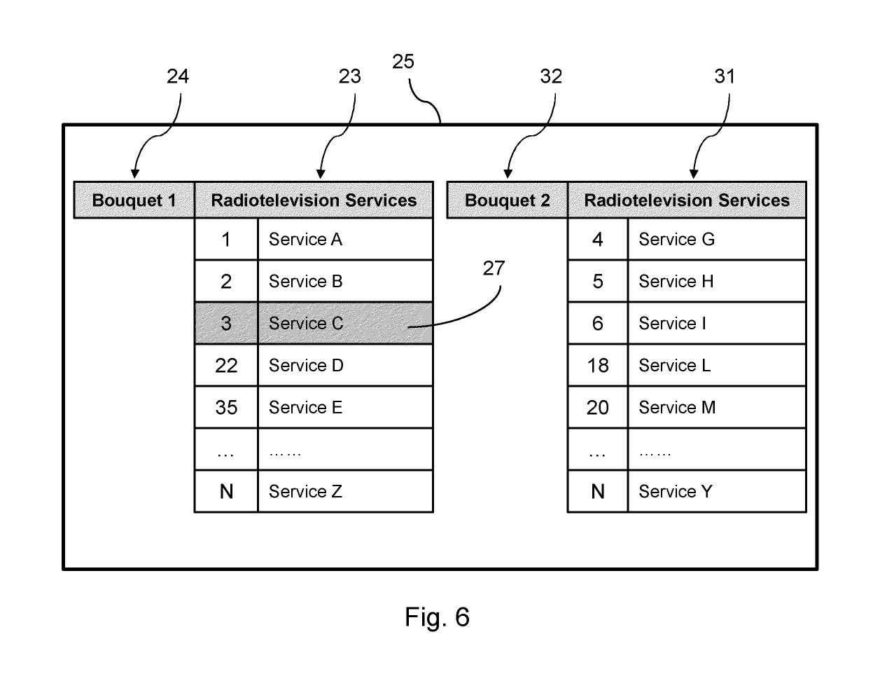

With reference to FIG. 6, an alternative display of the bouquet is illustrated, always comprised in a menu system, in which the first radio-television services 23 belonging to the first bouquet 24 are displayed simultaneously with the second radio-television services 31 belonging to the second bouquet 32. In this case, the user is always able to select a single television service 23, 31 through use of the cursor 27 within a single list of services 23, 31, but is also able to move the cursor 27 from a first list of radio-television services 23 to a second list of radio-television services 31, and vice versa.

These operations can be carried out inside the menu functioning by of at least one command given by the user, which in this context can take advantage of the selection means, in particular, a cross-shaped control panel (including the Up, Down, Left and Right buttons), now present on almost all remote controls, to easily move between the different radio-television services 23, 31.

In general, the control panel includes four buttons which form a cross, and are used to browse the menu of the television apparatus. However, if the user does not call up a menu, said cross shaped buttons remain inactive or do the functions described in the previous embodiments.

Therefore, a configuration of the selection means provides that the same are provided for via a cross shaped keypad, and the buttons which compose it can be used in order to allow browsing within at least a bouquet 24, 32 when the menu function is activated.

In this case, the method according to the invention provides for moving, via the radio-television apparatus and following a user initiated command, a cursor 27 through radio-television services 23, 31 within at least one bouquet 24, 32. Additionally, the method according to the invention provides to assign the control of a movement of said cursor 27 to at least one of the four buttons in the form of a cross on a remote control.

Additionally, the display of the radio-television services in the form of a list can be carried out by grouping these services by multiplexes rather than broadcasters.

In a further variant of the invention the selection of bouquets and the browsing of the same can be performed via voice commands, being as that modern radio-television apparatuses are equipped with voice recognition systems. According to this way of operating the apparatus, upon turning on the device the user can give the voice command “RAI”. In this way the apparatus is tuned, as before, thanks to the table stored in its first memory means, to the first service contained in the RAI bouquet. Such first service may be the one that has the lowest LCN value or may be the one most frequently viewed by the user within the bouquet. In this case it is necessary that the apparatus keep within its memory the number of times that a given service has been viewed by the user of the apparatus in a predetermined period of time, for example in the last 12 months.

With this solution it is easier to pass from one broadcaster's bouquet to another, even if they are not contiguous. Once a bouquet has been chosen from those available, for browsing through the services, it is possible use, for instance, voice commands such as “up” or “down”.

In this case, the selection means also comprise voice recognition means and a microphone, the latter being integrated in the television apparatus or in the remote control.

The television apparatus according to the invention is configured to implement the method according to the invention in its embodiments as described herein above.

The television apparatus may be a television set or any electronic device able to receive radio-television signals, via radio or cable.

More specifically, the television apparatus includes receiving means, in particular an antenna and at least a radio-television receiver, designed for receiving and decoding a broadcasting signal, such broadcasting signal including bouquet, broadcaster and multiplex information relating to radio-television services. It is clear that the bouquet, broadcaster and multiplex information can be received by the apparatus in other ways. For example, the receiving means may include a network interface for connecting to the Internet network, via cable or wireless, so as to find the bouquet, broadcaster and multiplex information, for example downloading such information from a database located on a remote server.

Additionally, the radio-television apparatus comprises first processing means and the first memory means. The bouquet, broadcaster and multiplex information, once received by the receiving means, is stored in the first memory means via the first processing means.

Again with reference to the FIGS. 1 and 2, the bouquet, broadcaster and multiplex information is stored in the first memory means of the radio-television apparatus and used by the first processing means to implement the method according to the invention. To view the television services belonging to a bouquet, broadcaster and/or multiplex the television apparatus is associated with display means, in particular a screen. Therefore, the television apparatus can integrate a screen, or be connected to one via a dedicated audio/video communication interface, such as HDMI (“High Definition Multi Media Interface”), SCART (“Syndicat des Constructeurs d'Appareils Radiorecepteurs et of televisions”), VGA (“Video Graphics Array”) wirelessly Wi-Fi (“wireless fidelity”) and so on.

As already said, the radio-television apparatus includes selection means, and in particular includes a keypad with buttons arranged in a cross shape, colored buttons, dedicated buttons, and so on.

The invention also relates to a computer program product loadable in the first memory means of said television apparatus and comprising software code portions adapted to implement the method according to one or more of the embodiments of the invention described herein.

The remote control according to the invention can be a normal remote control, a voice recognition remote or an electronic device provided with second display means, for example a smartphone or a tablet, having one or more of the above characteristics.

In particular, the remote control according to the invention is adapted to cooperate with the radio-television apparatus and comprises second processing means, second memory means and selection means adapted to implement the method according to the invention. The selection means, in particular, include a control panel with buttons or icons in the shape of a cross, colored buttons and so on. Additionally, the selection means of the remote control may include a microphone and/or a voice recognition system.

Preferably, the selection means comprise a keypad having buttons or icons arranged in a cross shape wherein the first selection means are a next bouquet button/icon “B+” and a previous bouquet button/icon “B−”. Therefore, the next bouquet button/icon “B+” and the previous bouquet button/icon “B−” allow for changing bouquet, or to select the desired bouquet from those available, for example, among those identified by the radio-television apparatus. The second selection means are a next program (service) button/icon “P+” and a previous program (service) button/icon “P−” that allows for selecting radio-television services in a selected bouquet, or rather current.

In particular, the next bouquet function “B+” is assigned to the “Right” button/icon of the cross, the previous bouquet function “B−” is assigned to the “Left” button/icon of the cross, the next program (service) function “P+” is assigned to the “Up” button/icon of the cross, and the previous program (service) function “P−” is assigned to the ‘Down’ button of the cross.

Currently, some smartphones are capable of interacting with a television apparatus in various ways, for example via Wi-Fi (“wireless fidelity”), or Bluetooth, or even via infrared. This communication allows them to function as traditional remote control units. Therefore, the remote control according to the invention can be implemented via a smartphone or tablet.

Additionally, the remote control according to the invention can be a “smart” programmable remote control. In particular, it may comprises an interface, for example with or without wires, able to connect to an external electronic device. For example, the interface could be of the USB type (“Universal Serial Bus”) which allows for connecting the remote control to a computer in order to download the bouquet, broadcaster and/or multiplex information. Alternatively, the interface can be a Wi-Fi type so that the remote is able to connect to the Internet and download the bouquet, broadcaster and/or multiplex information from a website or remote server. It is clear that different types of interfaces can be implemented in the remote control by the expert of the art.

This would allow browsing within the selected bouquet of a broadcaster and/or multiplex and to switch from one bouquet, or multiplex, to another in an easy and immediate manner, simply pressing dedicated buttons/icons.

In this case, the operational logic is implemented in a software (e.g. an “App”) stored in the second memory means of the “smart” remote control, or a smartphone, or tablet, in order to allow browsing between radio-television services per bouquet or per multiplex.

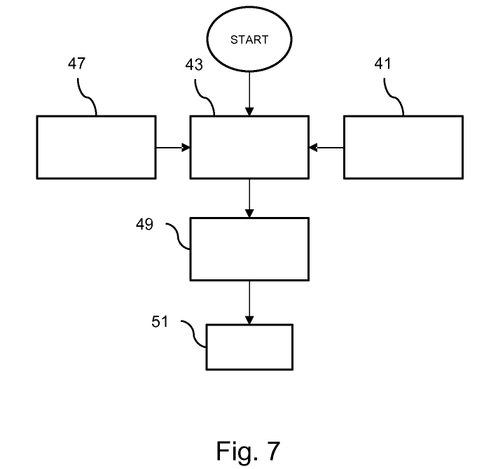

With reference to FIG. 7, a flow chart is illustrated which exhibits a logical sequence of the functions to be performed by the software application.

The operational logic requires that the “smart” remote control, or smartphone, perform the reading of both the bouquet information (logic block 41), namely a table relative to the required bouquets, and the information relating to radio-television services, with the information about the receivable and available multiplexes and LCN (logic block 47). Therefore, the logic block 43, is set to make a correspondence between the radio-television services and the bouquet and/or multiplex.

Subsequently, with logic block 49, a new list of the bouquet and/or multiplex is produced with the association to the relative services available that can be received. The new list, i.e. the list of bouquets and/or multiplexes with the sequence of services (LCN) associated to each of them, can be made available to the television apparatus (for example, “iDTV”, or set-top-box). Preferably, it is the “smart” remote control, that stores the abovementioned list, and calls (LCN) the desired radio-television service (e.g. via its infrared output) to the television apparatus (logical block 51).

Advantageously, if the above list of bouquets and/or multiplexes is only stored in the “smart” Remote Control, it is possible to use any television apparatus known in the art, since the latter will only be limited to receive the command relative to the radio-television service selected to be tuned.

Additionally, if one considers a smartphone, or tablet, with a touch screen, the buttons are virtual and visible on the screen as icons, some of which carry out the next bouquet function “B+” and previous bouquet function “B−” as described above.

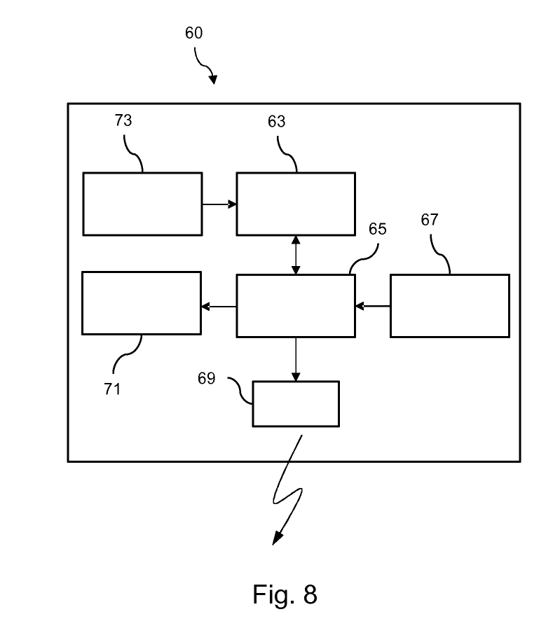

With reference to FIG. 8, a block diagram is illustrated of an example of a “smart” remote control 60. The remote control 60 comprises second memory means 63, second processing means 65 and transmission means 69 able to transmit a control signal for the television apparatus. As already mentioned, the operating logic is implemented in a computer program product loaded in the second memory means 63 of the remote control 60. The second processing means 65 allow to perform the logical operations of the flow chart of FIG. 7.

The transmission means 69 can be, for example, an infrared port, a communication module, Wi-Fi, or Bluetooth, and so on.

Furthermore, the remote control 60 includes selection means 67, in particular a control panel which in turn includes dedicated buttons for the selection of the next bouquet “B+” and the previous bouquet “B−”, performing the functions previously described in the method according to the invention.

Alternatively, or in combination, the selection means 67 are virtual buttons/icons displayed on a screen 71 of the remote control 60, some of these virtual buttons implement the next bouquet “B+” and previous bouquet “B−” functions described herein above.

The remote control unit 60 also comprises communication means 73, in particular a USB (“Universal Serial Bus”), able to connect to an external electronic device, such as a computer, and able to receive both the bouquet information (refer the logic block 41 of FIG. 7), namely a table relative to the required bouquet, and the information relating to radio-television services, with the receivable and available multiplex and LCN (refer to logic block 47 of FIG. 7).

Furthermore, a computer program product that can be uploaded to the second memory means of said remote control includes software code portions able to implement the method according to one or more of the embodiments of the invention as described.

There are numerous possible variants to the method, television apparatus and remote control for browsing through radio-television services described as an example, without departing from the novelty principles inherent in the inventive idea, as it is also clear that in its practical forms of implementation the illustrated details can be different, and the same may be replaced with technically equivalent elements.

For instance according to a variant, the usual selection means, namely, the buttons or icons “P+” and “P−”, can allow for normal browsing according to the LCN numbering if tuned to a radio-television service that is not part of any bouquet.

In particular, all embodiments of the method expressed herein for the bouquet can be applied to a multiplex.

Therefore it is easily understood that the present invention is not limited to a method, a television apparatus and a remote control for browsing through radio-television services, but is subject to various modifications, improvements, substitutions of parts and elements without departing from the inventive idea of the invention, as is better clarified in the following claims.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1: A method for browsing through radio-television services, each of said radio-television services belonging to a respective broadcaster from among a plurality of broadcasters, and being contained in a respective broadcasting multiplex among a plurality of broadcasting multiplexes, said method comprising the steps of:
identifying a first broadcaster from the plurality of broadcasters, a first multiplex from the plurality of multiplexes, or both, to which at least one radio-television service belongs;
selecting, by way of a selection means, a service from among the plurality of services available; and
sequentially selecting, by way of said selection means, radio-television services belonging to the first broadcaster or to the first radio-television multiplex.

2: The method according to claim 1;
wherein said selection means comprises:
a first selection means configured to select a bouquet of said first broadcaster from among a plurality of available bouquets, or a multiplex from among a plurality of available multiplexes; and
a second selection means configured to select said radio-television services from within said selected bouquet, or multiplex.

3: The method according to claim 2;
wherein said step of selecting a bouquet, or a multiplex, provides for tuning a radio-television service belonging to said bouquet, or multiplex.

4: The method according to claim 3;
wherein, when a bouquet or a multiplex is selected, said radio-television service is associated with the lowest Logical Channel Number (“LCN”) number from among LCN numbers of a plurality of radio-television services belonging to said bouquet, or multiplex.

5: The method according to claim 2, further comprising:
browsing, via said second selection means, based on Logical Channel Number (“LCN”) numbering if the tuned radio-television service is not part of a bouquet, or multiplex.

6: The method according to claim 2;
wherein said first selection means, said second selection means, or both, select in a circular manner said radio-television services belonging to said selected bouquet, or multiplex.

7: The method according to claim 2, further comprising:
changing the bouquet, or multiplex, via said selection means, once all the radio-television services present in said selected bouquet have been selected, or tuned.

8: The method according to claim 7;
wherein said step of changing the bouquet, or multiplex, provides for selecting a second radio-television service belonging to a second bouquet, or multiplex, said second radio-television service having a Logical Channel Number (“LCN”) number being successive to a starting radio-television service from which browsing of said selected bouquet, or multiplex began.

9: The method according to claim 1, further comprising:
storing said starting radio-television service so as to obtain a Logical Channel Number (“LCN”) number of said second radio-television service.

10: The method according to claim 2, further comprising:
browsing, via said selection means, among radio-television services belonging to said bouquet, or multiplex, selected in an incremental or decremental manner.

11: The method according to claim 2;
wherein said selection means comprise a keyboard with at least four buttons or icons arranged in a cross shape comprising two opposite first buttons that are opposite to each other, and two opposite second buttons that are opposite to each other;
wherein said selection of a bouquet, or multiplex, is associated with the opposite first buttons of said cross; and
wherein said selection of radio-television services within said selected bouquet, or multiplex, is associated with the opposite second buttons of said cross.

12: The method according to claim 1;
wherein said selection means comprise speech recognition and a microphone configured to receive voice commands from a user.

13: The method according to claim 1, further comprising:
selecting a default bouquet, or multiplex, via said selection means.

14: The method according to claim 1;
wherein said selection of a default bouquet, or multiplex, is associated with colored buttons or icons present on a remote control.

15: The method according to claim 1;
wherein said selection of a bouquet, or multiplex, and said selection of radio-television services within said selected bouquet, or multiplex, is associated with the colored buttons present on a remote control.

16: The method according to claim 1;
wherein said selection means are configurable by the user.

17: The method according to claim 1;
wherein said selection means are configurable via a menu of a radio-television apparatus.

18: The method according to claim 1;
wherein said selection means are configurable via said colored buttons present on a remote control.

19: The method according to claim 1;
wherein said radio-television services are displayed grouped by bouquet, broadcaster, multiplex, or a combination thereof, in the form of a list.

20: A radio-television apparatus to implement the method according to claim 1, comprising:
first processing means;
first memory means; and
said selection means.

21. (canceled)

22: The radio-television apparatus according to claim 20;
wherein said first memory means stores bouquet information, broadcaster information, multiplex information, or a combination thereof.

23: The radio-television apparatus according to claim 22;
wherein said bouquet information, broadcaster information, multiplex information, or combination thereof, includes at least a name, or code, of a radio-television service associated with a bouquet, broadcaster, multiplex, or combination thereof.

24: The radio-television apparatus according to claim 20, further comprising:
a display means.

25: A remote control configured to cooperate with a radio-television apparatus to implement the method according to claim 1, and comprising:
second processing means;
second memory means; and
said selection means.

26: The remote control according to claim 25;
wherein said remote control is programmable and comprises at least an interface configured to receive bouquet information, broadcaster information, multiplex information, or a combination thereof, and to store said received information in said second memory means.

27: The remote control according to claim 25;
wherein said remote control is a smartphone or a tablet.

28: The remote control according to claim 25;
wherein said remote control includes a microphone configured to receive voice commands in order to implement the method according claim 1.

29: A computer program product configured to be loaded in a first memory means of a radio-television apparatus, in a second memory means of a remote control, or in both, the computer program product comprising:
software code portions comprising instructions that, when executed, implement the method according to claim 1.
